(19) United States
(12) Patent Application Publication
(10) Pub. No.: US 2022/0058518 A1
(43) Pub. Date: Feb. 24, 2022

(54) Using machine learning algorithms and nanotechnology combinations to clean an indoor environment.

(71) Applicant: Keith Louis DeSanto, St Petersburg, FL (US)

(72) Inventor: Keith Louis DeSanto, St Petersburg, FL (US)

(21) Appl. No.: 17/000,329

(22) Filed: Aug. 23, 2020

(51) Int. Cl. G06N 20/00; G06F 16/2458; G06F 16/11

(52) U.S. Cl. CPC G06N 20/00; H04N 5/23296; G06F 16/11; G06F 16/2465

(57) ABSTRACT

The unsanitary conditions in an indoor environment that microbes create such as pollution or contamination may be airborne or on surfaces. Our new application is an identifier and elimination of microorganisms that cause disease and death to humans, plants and animals in an indoor environment using a combination of artificial intelligence and nano-technologies. The entire interconnected artificial intelligence platform consists of machine learning algorithms, chatbots, cloud computing, data mining, exascale calculations, drones, robots, high definition cameras and nanotechnology cantilever arrays with and without canisters.

### DESCRIPTION OF VIEWS

Purpose of the camera in our artificial intelligence platform is to take microscopic pictures and video of microbes, pathogens or viruses in an open and closed canister.

Purpose of the cantilever in our artificial intelligence platform is to have microbes and clusters of microbes enter and leave the canister to either be weighed, taken pictures of or both.

The purpose of the canister housing the camera and cantilever is to isolate microbes from other matter or forces for pictures and video. If the pictures and or video are inconclusive, the cantilever will be used to weigh the microbe.

There are four external doors to each canister, two in the front and two in the back that open and close on microbe entrance into canister using a vacuum or air bursts. Cleaning of microbes and foreign matter from inside the canister can either utilize vacuums, air bursts, continual air flow, steam or various cleaning solutions. The camera lens and the cantilever may need cleaning periodically during the detection process or once daily.

The two internal doors close automatically around the camera and beam to isolate the microbe from others when the beam or camera senses matter. Many calculations lead to many repetitive steps where doors may open and close many times per detection run. The two internal doors open when either the front or back doors are open.

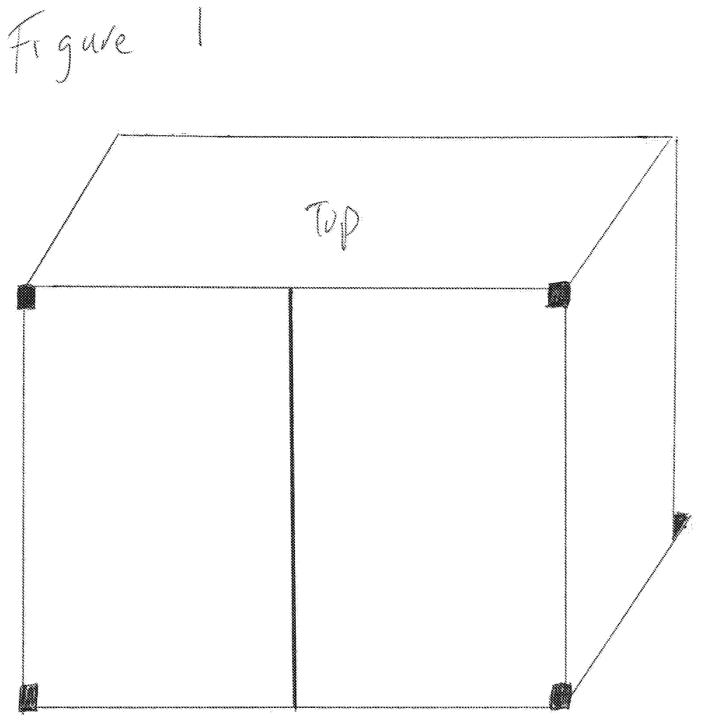

FIG. 1 is a front view of the closed canister.

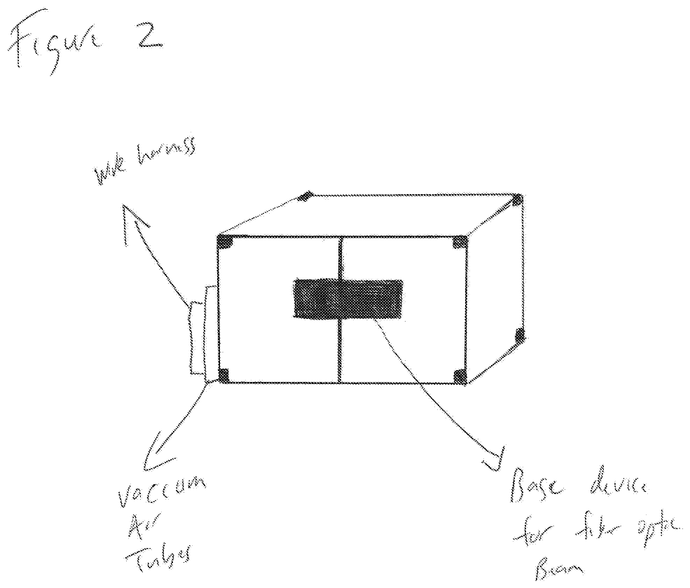

FIG. 2 is a rear view of the closed canister.

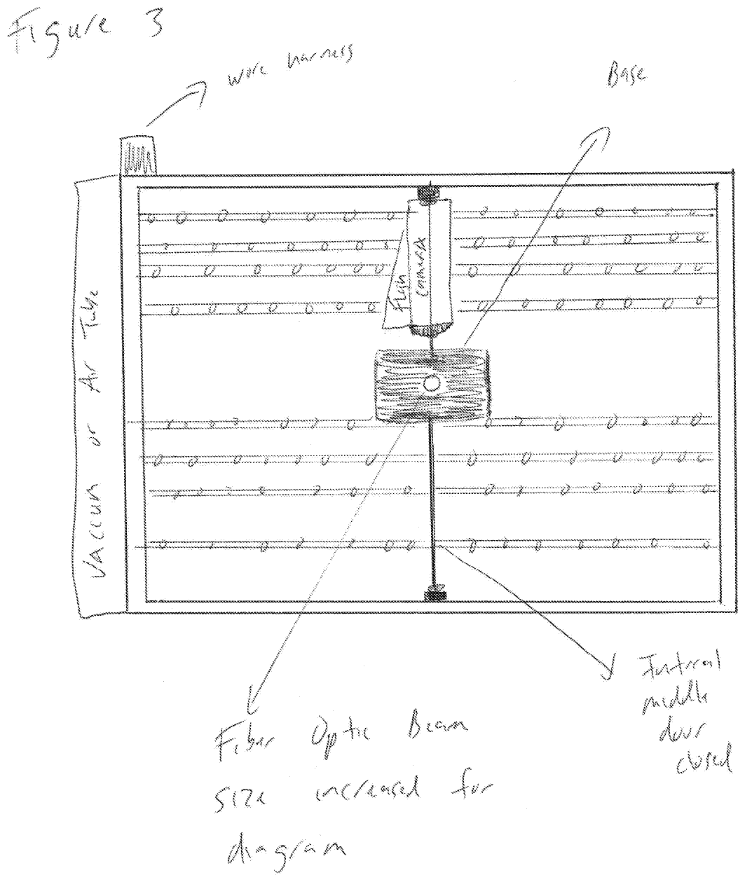

FIG. 3 is a front view of the canister doors removed.

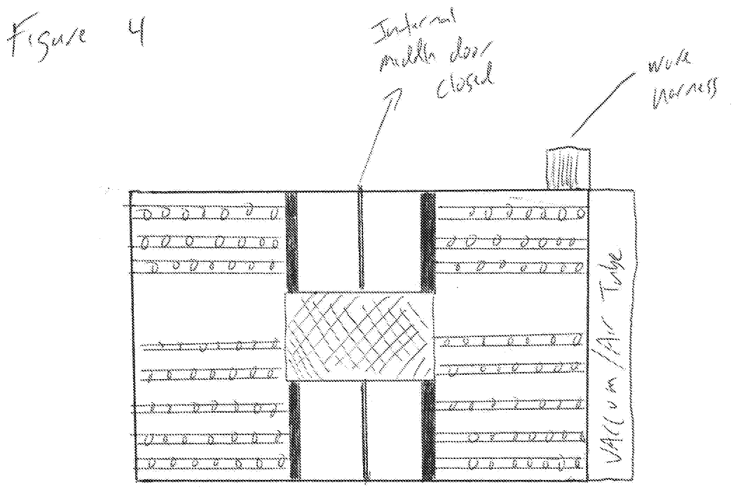

FIG. 4 is a rear view of canister doors removed

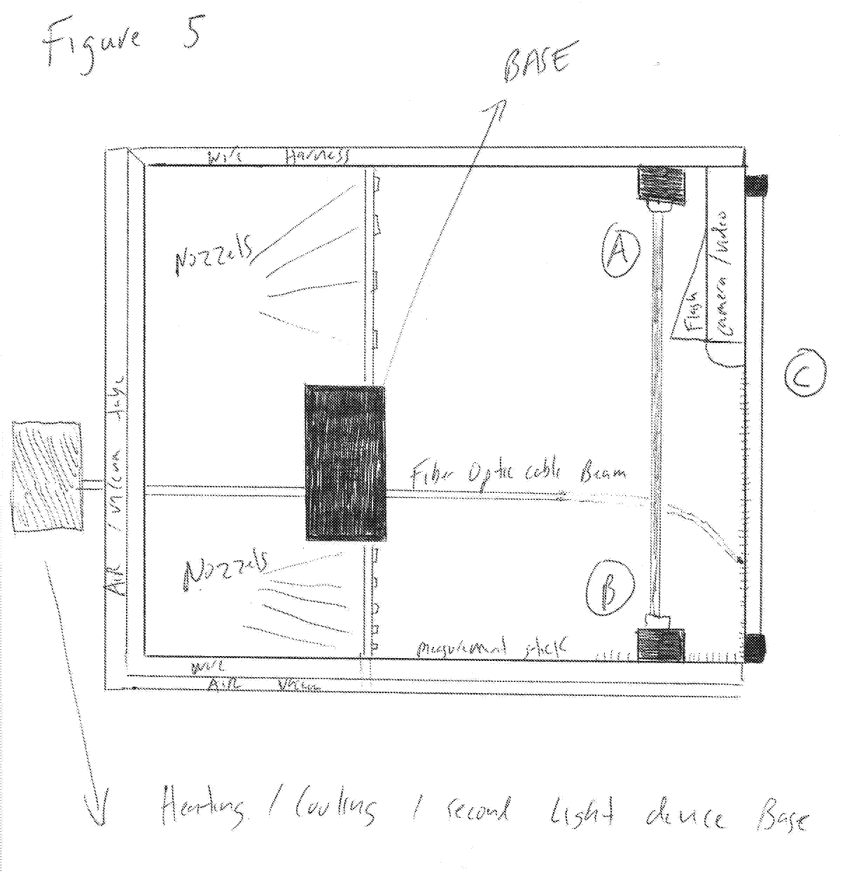

FIG. 5 is a left side view of canister door removed showing a fiber optic cable and camera.

The schematic view of the cantilever as shown in FIGS. 1 through 5 is described below.

FIG. 1.

The figure shows a canister “box” with hinges on the sides for opening and closing the doors. The doors open from the center and open to the left and right of the canister.

FIG. 2. shows same canister with hinges on the outside corners to open the canister from the back. The black box in the center of the diagram is the base for the fiber optic cable beam and the lighting device for the fiber optic cable beam that weighs microbes. The diagram shows the left-hand side of wire cable harness and vacuum and air tubes.

FIG. 3. shows the front view of the canister with outside doors removed showing:

Front tip of fiber optic beam

Front view of black box base housing the lighting device (rear of box) and the fiber optic beam at the immediate front.

Wire harness on right hand side top.

Vacuum and air tubes.

Total of 9 vacuum and air tubes (horizontal with round holes) which air can either be sucked in via vacuum device (with microbes) or air can be blown in or pulsed to blown out (remove microbes and other unwanted matter) by compressed air container or similar device.

Microscopic camera or cameras are fixed right above beam in FIG. 3 where the camera can take continual pictures and or video of matter resting on beam or in view of camera traveling through the canister.

FIG. 4. Back view of Cantilever Canister with doors open without camera. This view shows:

Wire harness (top right) with vacuum and air tubes parallel feeding the horizontal air tubes (right of wire harness) with the middle two doors around the beam closed. The two black columns in the middle of diagram (perpendicular) are support struts holds the wires, beam base, the air tubes and the canister together. The support struts may also encase wires.

FIG. 5. Left hand side of canister with panel removed where the front of the canister is right and the back is left. The diagram shows:

Fiber optic cable bending with microbe on end.

Figure A shows the left front internal door closed around the freely moving up and down beam

Figure B shows the right front internal door closed around the freely moving up and down beam

Figure C shows the front external door closed with the measuring stick affixed to the inside of door for beam measurement inflection.

To the right of figure C is the camera that takes microscopic video and pictures of microbes with flash.

The center black box is the base for holding the beam and lighting device for beam.

The black box outside of the canister on the left-hand side is the second base for beam and lighting device for heating and cooling if needed.

On the top and bottom of the right-hand side of base is the air and vacuums nozzles.

The top and bottom of canister container shows wire harnesses for the doors, camera, flash, air pressure and vacuum device and door hinges. The fiber optic cable is on a separate power source called the base.

The back part of the canister shows the vacuum and air pulse/burst tubes.

1. An application where an artificial intelligence platform consisting of machine learning algorithms, chatbots, cloud computing, data mining and exascale calculations combine with nanotechnologies which include drones, robots, high definition cameras and cantilevers.

2. An application where interconnected artificial intelligence platforms being machine learning algorithms, chatbots, cloud computing, data mining and exascale calculations combine with nanotechnologies which include drones, robots, high definition cameras and cantilevers.

3. An application in claims 1 and 2 where artificial intelligence and combination nanotechnologies identify and eliminate microorganisms that cause disease and death to humans, plants and animals in an indoor environment on surfaces and in the air.

4. An application where artificial intelligence and nanotechnology are used as an identifier of microorganisms on surfaces and in the air that cause disease and death to humans, plants and animals in an indoor environment using interconnected artificial intelligence platforms, algorithms, chatbots, cloud computing, data mining and exascale calculations, drones, robots, high definition cameras and cantilevers.

5. An application where artificial intelligence and nanotechnology are used to eliminate microorganisms on surfaces and in the air that cause disease and death to humans, plants and animals in an indoor environment using interconnected artificial intelligence platforms, algorithms, chatbots, cloud computing, data mining and exascale calculations, drones, robots, high definition cameras and cantilevers.

6. An application in claims 1 through 5 where the applications can be mobile or stationary.

7. An application in claims 1 through 6 where a high definition camera can magnify the images of a viruses, pathogens, biological warfare germs, molds, and allergens so that the machine learning platform can learn and identify them and build a database of such.

8. An application in claims 1 through 7 where the camera is a nano-micro-camera-scope that can magnify images from 400 to 1060 times.

9. An application in claim 8 where the artificial intelligence combination technology platform learns the color, size, and identity of microbes and clusters of microbes.

10. An application in claims 1 through 9 where open and closed canisters and open tubes hold arrays of cantilevers.

11. An application in claims 1 through 10 where the application uses glass or silicon fiber optic strands as a weighing and measurement beam.

12. An application in claims 10 and 11 where the cantilever uses light in a glass or silicon fiber optic strand as a beam for weight and measurement of microorganisms.

13. An application in claims 1 through 6 where the application uses manned and unmanned autonomous drones and robots that can disassemble and reassemble themselves.

14. An application in claims 1 through 13 where the cantilevers weigh microorganisms in femtograms (10⁻¹⁵)

15. An application in claims 1 through 14 where the cantilevers can weigh viruses in yoctograms (10⁻²⁴)

16. An application in claims 1 through 15 where the arrays of cantilevers can be more than one and up to 9,400,000 cantilevers in a single mobile or stationary platform.

17. An application is claims 11 and 12 where the fiber optic beam can be heated, chilled, or magnetically charged.

18. An application in claim 10 where a canister (insulated with fiberglass and or mineral wool) is heated up to 2499 degrees Fahrenheit to destroy microorganisms.

19. An application in claims 1 through 17 where the artificial intelligence platform and combination nanotechnologies deploy an electrostatic biosurfactant peptide spray that determines which dilution, ratio of mono-to di-rhamnolipid and which carrier will eliminate microorganisms and leave a biofilm to deter the formation of microorganisms and clusters.

20. An application as in claim 1 through 9 that creates a 3-dimensional layout of an indoor environment in data terms to determine what to clean and how to clean it.
